(19) United States
(12) Patent Application Publication
(10) Pub. No.: US 2016/0143254 A1
(43) Pub. Date: May 26, 2016

(54) TUG A TUNE

(71) Applicant: ROHAN SHAANTI, Toronto (CA)

(72) Inventor: ROHAN SHAANTI, Toronto (CA)

(21) Appl. No.: 14/946,234

(22) Filed: Nov. 19, 2015

Related U.S. Application Data
(60) Provisional application No. 62/082,577, filed on Nov. 20, 2014.

(51) Int. Cl. A01K 27/00; A01K 13/00

(52) U.S. Cl. CPC A01K 27/009; A01K 27/003; A01K 27/001; A01K 13/006; A01K 27/008

(57) ABSTRACT

The present invention is a leash, collar, harness, and jacket for pet animals that embodies air-activated sound making devices, such as air sacks with reeds, whistles, horns, bells and shakers to allow for one way or two way communications between an animal and a human. Said sound making device is made of a reed embedded in an air pocket or air pouch or idiophone instruments attached to a leash, harness, collar or jacket. Said sound device can be activated through biting or pulling or movement by the animal and squeezing by the human.

### RELATED APPLICATIONS

The present patent application claims the priority date of the provisional patent application No. 62/082,577 filed on Nov. 20, 2014.

### FIELD OF THE INVENTION

The present invention relates in general to devices that facilitate communication between animals and humans, and in particular to sound making devices incorporated on animal leashes, collars, harnesses and jackets that embody squeezable and shakable sound makers for two way communication between humans and animals.

### BACKGROUND OF THE INVENTION

Animals can be trained to perform duties to response to specific clues, which are important to communicate with the human. Animals can also learn from their experiences, and learn through trainings which provide positive and negative feedback in response to their behaviours. Training may be for various purposes such as communication, protection, and entertainment. For example, a seeing-eye dog will be trained to achieve a different goal than a wild animal in a circus.

Communication between human and animals have been considered for years. Animals, especially training animals like dogs, respond to the humans and if trained, are capable of understanding many instructions issued from humans in language or voice tone form. Each of these animals may serve as not only human's pets but also as human's partners in various kinds of activities. Current inventions want to simplify training the animals by providing methods to use the instinct of the animals in training. An animal may learn to use the methods through associative learning after it sees the predictably of some response to a behaviour. Trainers should consider the natural behaviours of the animal and aim to modify behaviours through a basic system of reward and punishment.

Research confirms that dogs have sound preferences and react differently to particular types of sounds. In this case various sound clickers, electric shock collars, training aid bell and electronic sensors have been described in prior art.

Dog collars that embedded air pockets to reduce stress on an animal's neck when pulling, is also described in the art, but it does not embody sound devices on the collar.

A need exists for an animal-human communication device that is non-electronic and uses a reed-activated sound system that an animal reacts to.

### SUMMARY OF THE INVENTION

The present invention is a leash, collar, harness, and jacket for pet animals that embodies air-activated sound making devices, such as air sacks with reeds, whistles or horns. The sound making devices are strategically installed in the leash, collar, harness, or jacket of a pet, to facilitate commutation between the pet and a human. The sound making devices comprise of reeds embedded in air pockets or air pouches that are attached to a leash, harness, collar or jacket. Sounds are made when the air pockets are compressed, forcing air over reeds that vibrate, creating a sound.

The sound device can be activated through biting or pulling by the animal and squeezing by the human. The air-activated sound making device is located on 8″-24″ above the latch to make sound whenever it is over pulled by a dog. The sound making air pouch device can also be bitten by a dog to make a sound. A variety of sound making air pouch devices is designed for specific responses and for specific conditions, such as communication, protection or other purposes.

A set of sound making air pouches can also be located on the collar near the throat of a dog and can make sound whenever they are pulled hard by the dog. These air pouches have other functionalities, such as acting as an air cushion for comfort, and as a noise alert for dog and human.

A second set of sound making air pouch devices are located on the leash near the handle of the leash to let a human make a sound to communicate with the dog.

Sound making air pouch devices produce multiple sounds with variety of tones, each for specific action and for multiple commands. The animal can be trained to respond to each action or command corresponding to a note pushed by the user.

For example, trained dogs, such as seeing-eye dogs, can use the present invention to notify their human companion of certain messages they wish to convey by biting on a note. Similarly, a human can push a note, requesting a task from the dog. For training, higher tones generally enforce good behaviour while lower tones generally enforce bad behaviour. Most animals respond to these tones naturally. One or multiple notes or air-activated sound devices may be found on the device.

The present invention may be a set of independent sound making devices that are attached to a leash, collar, harness or jacket, or may be a one piece device with any combination of leash, collar, harness or jacket. The leash embodies sound devices near the handle for the human trainer to push and activate. The leash may also embody sound devices slightly above the latch, for the animal to bite and activate, allowing the leash to be used as a tug of war toy and sound toy for both human and animal to engage, or two animals to engage. The leash may also embody multiple air-activated notes on its fabric, letting the animal use the leash as a toy, with notes that the animal can bite, or a human can push. The collar embodies a set of sound devices near the throat area which are activated by over-pulling from the animal, or pulling on the leash by the trainer. The collar and leash also can embody flexible materials to help reduce stress on animal's neck when pulling. The harness and jacket embody air-activated sound devices for the animal to activate by biting, and a human by pushing, enabling communication between animal and trainer. The harness and jacket may also embody shakable musical instruments such as bells, shakers, or chimes, that make sounds as the animal moves, allowing an human that is seeing impaired know exactly where the dog is.

It is an object of the present invention to provide a communicating device so that humans and animals can communicate with each other through sound tones, humans by pressing with hand, animal by biting with teeth or pulling.

It is an object of the present invention to provide a communicating device so that seeing impaired users can hear their dog walking.

It is another object of the present invention to provide a device that human can call a dog for a walk with without speaking.

It is another object of the present invention to provide with a squeezable sound device located on the collar and or harness so that a human and animal will know if the animal is pulling too hard.

A current problem with dog leashes is that they do not have a calling device for dogs. When a dog is off the leash, a human calls the dog with their voice. It is another object of the present invention that is useful for speech impaired users or seeing impaired users so that an animal can communicate with a human by biting sound tones on their jacket, indicating commands such as “Stop”, “Go”, “Feed me” by the sound tone they are biting.

It is another object of the present invention to help reinforce behaviour with animals and break up animal fights, to help call animals that are off the leash and train and discipline them, help animals to communicate with humans and humans to animals, helps notify if an animal is tugging too hard, helps notify an animal if it is in danger, helps an animal learn music tones through play.

It is another object of the present invention to allow humans to communicate with animals, and animals to communicate with humans, without words or woofs.

Other objects, features, and advantages of the present invention will be readily appreciated from the following description. The description makes reference to the accompanying drawings, which are provided for illustration of the preferred embodiment. However, such embodiments do not represent the full scope of the present invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 is a view of the air-activated sound device embedded on a leash;

FIG. 2 is a view of the air-activated sound device embedded on a collar;

FIG. 3 is a perspective view of the air-activated sound device and idiophone sound devices mounted on a jacket;

FIG. 4 is an elevational view showing a dog supporting the present invention as a harness;

FIG. 5 is a perspective view of a leash equipped with sound device and other equipment;

FIG. 6 shows the sound device as an external component; and

FIG. 7 shows a leash, collar, jacket and external sound making device as a combined device.

### DETAILED DESCRIPTION OF PREFERRED EMBODIMENTS

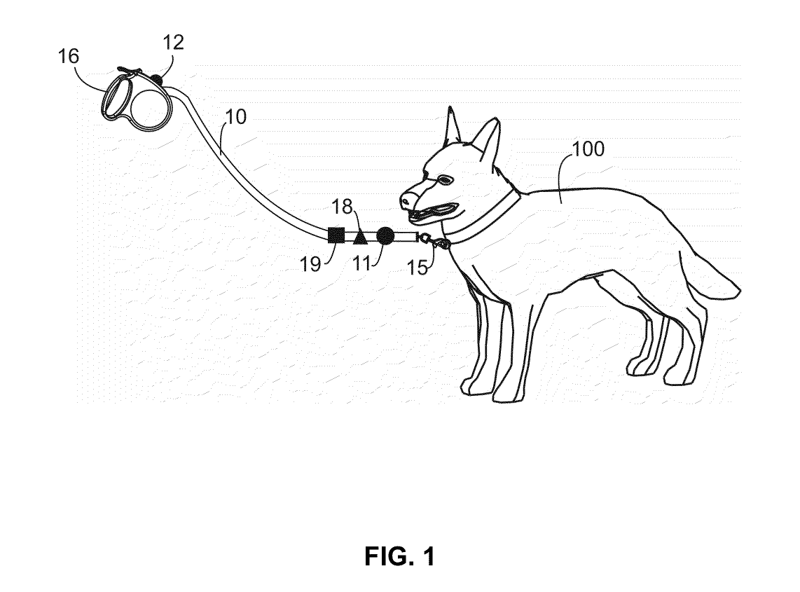

Referring to FIG. 1, a dog 100 on a leash 10 carrying the sound making device of the present invention. A first sound making device 11, 18 and 19 are associated with the dog 100 to communicate with the human and a second sound making device 12 is associated with human to communicate with the dog 100.

The sound making devices 11,12, 18 and 19 comprises an audible tone producing device such as reeds, whistle or horns embedded in an air pocket or air pouch. The first sound making device 11, 18, 19 is attached to one end of a leash 10 by fastening means located 8″-24″ above the latch 15 of the leash 10. By pressing or biting the first sound device 11, 18, 19 an audible sound is emitted and the animal notifies the human companion of a task. By pulling the first sound device 11, 18, 19 an audible sound is emitted and the animal and human companion will hear a sound alarming that the animal is over-pulling.

The second sound making device 12 is mounted on the handle 16 of the leash 10 enabling the human to produce sound to communicate with the dog 100. The human makes sound by squeezing the sound making device 12 to produce sound tones, thereby provide a two way communication between the dog 100 and a human. The humans and animals can communicate with each other through sound tones, humans by squeezing with hand and animal by biting the sound making device 11, 18, 19 designed on the distal end of the leash 10.

Again as shown in FIG. 1, there is a plurality of sound making devices 11, 18, 19 on the leash with different tones and different lengths from the distal end to help the dog 100 to communicate with the human with different devices that emit different sounds to emphasize different requests or tasks.

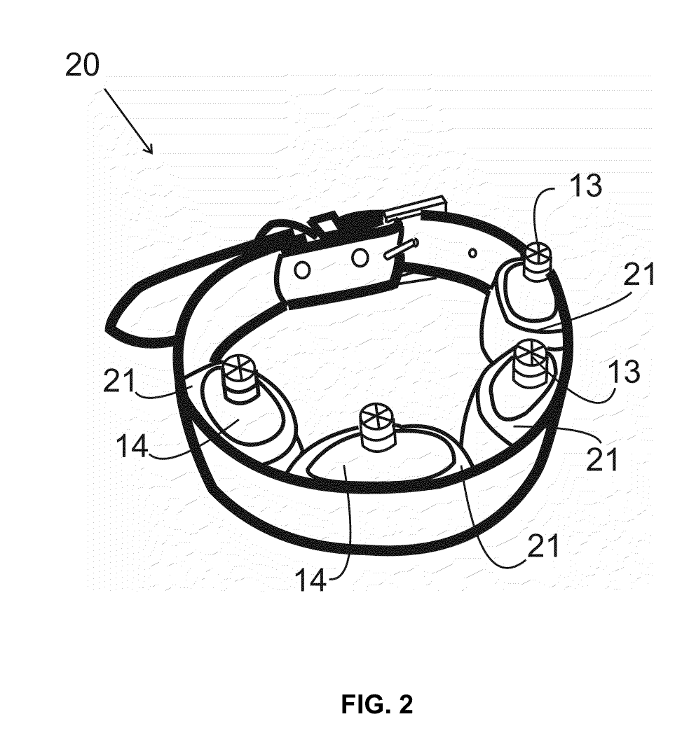

FIG. 2 shows a collar 20 with sound making device 21 embedded thereon. The sound making device 21 can be located on the collar 20 near the throat of the dog and can it make sound whenever it is pulled hard by the dog to communicate with a human. The sound making device 21 comprises of an audible tone producing device 13 such as a reed, a whistle or a horn embedded in an air pocket or air pouch 14. The air pouches 14 of the sound making device 21 have other functionalities, such as acting as an air cushion and as a noise alert for the dog. The sound making device and collar further has a Velcro cover and buttons or clips to strap additional devices such as light thereon.

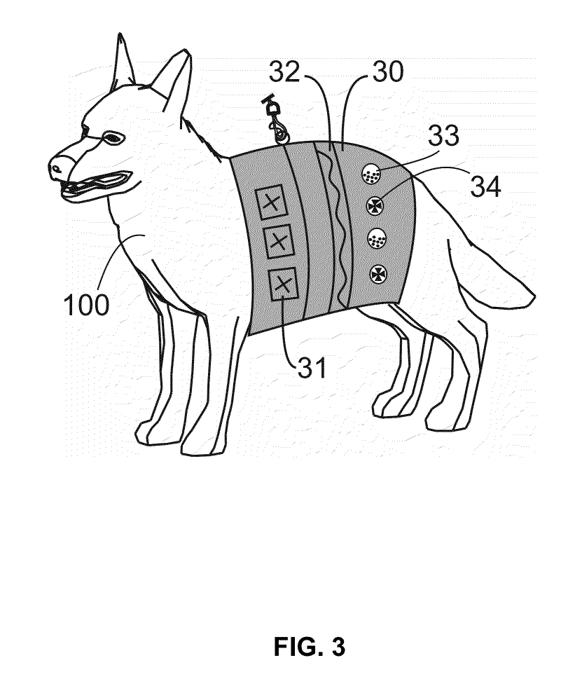

Referring to FIG. 3, the sound making device 31 is mounted on a jacket 30.

The sound making device 31 is then activated when the dog 100 bites on it. In another embodiment of the present invention, the sound making device 31 on the jacket 30 can be pushed by a human to communication with a dog 100. The jacket 30 functions by allowing an animal to bit a variety of sound makers, notifying the human companion of an action, such as “stop”, “go”, or “out” or “food”. High and low tones, can signal instructions such as Stop and Go, or Left and Right. Air-activated sound making devices may also extrude from the jacket with a shaft or pole closer to, and also infant of a dogs mouth. Additional air-activated devices may be added to the jacket that may embody a specially shaped pole or shaft for the dog to easily bite, creating a sound.

As shown in FIG. 3, a plurality of sound making device 31 designed on the jacket 30 to make different sounds and to be located in different location. The jacket 30 further has a Velcro strap 32 to help other attachments attach to the jacket 30, idiophone musical instrument such as shakers 33 and bells 34 which make sounds as the animals walk, helping seeing impaired users hear their dog while walking.

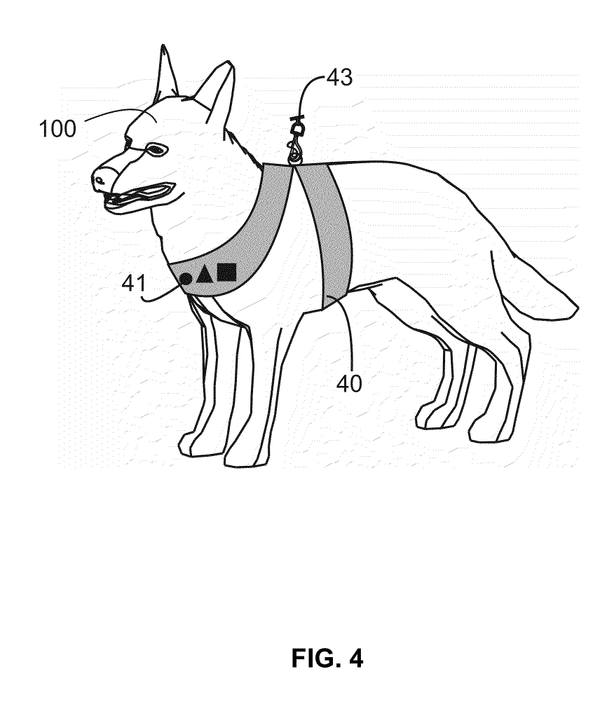

FIG. 4 shows the sound making device 41 mounted on a harness 40. The harness 40 functions when it is secured around the dog's body 100 and the dog 100 pulls on it hard enough. The sound making devices 41 are located near the chest and underneath the dog's head 100. The hook 43 connects the harness 40 to leash. As shown in FIG. 2, the sound making device 41 comprises of audible tone producing devices such as reeds, whistles or horns each embedded in an air pocket or air pouch. By puling or pushing on the air pouch, the device 41 makes sound.

The present invention may be an independent sound making device that is attached to a leash, a collar, a harness or a jacket, or it can be a one piece sound making device with any combination of a leash, a collar, a harness or a jacket.

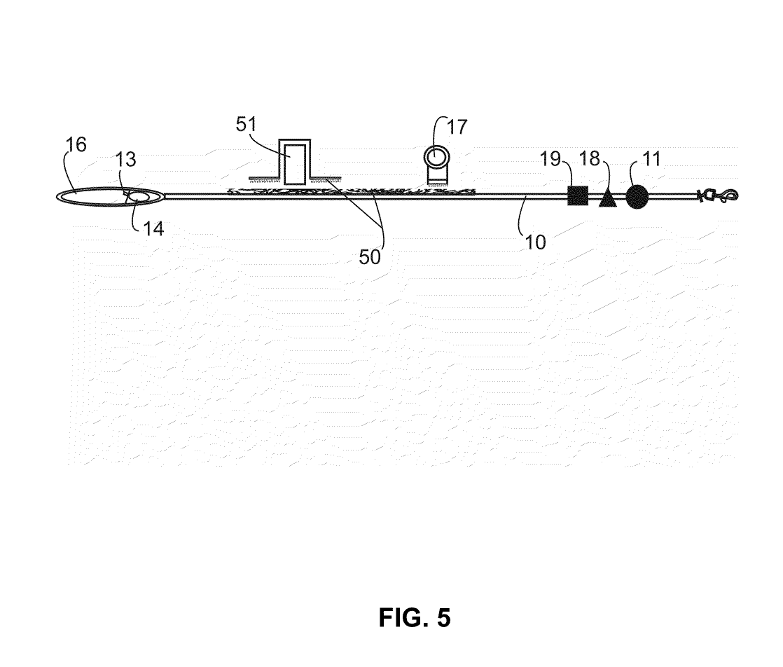

In FIG. 5, another embodiment of the present invention in conjunction with other equipment on a leash 10 is shown. The leash 10 have Velcro strap 50 for holding any related equipment for dog walking, dog training, toys, toilet bags, foldable feeding bowls 51, light or reflector 17. As shown in FIG. 5, any equipment related to the dog walking, dog training or similar can be attached to the leash 10 by Velcro strap 50 or buttons or clips to the body of the leash 10. A sound making device 11, 18, 19 in the distal end of the leash 10 on a leash handle 16 is shown, which embodies an audible tone producing device 13 such as reeds, whistle or horns in an air pocket 14. By such a design, the user can easily squeeze the air pocket 14 which is embedded inside the handle 16 and make a sound. By such design, the dog can pull on the leash and it will activate sound 11, 18, 19. By such design, the dog can bite on the sound device 11, 18, 19 and it will make a sound.

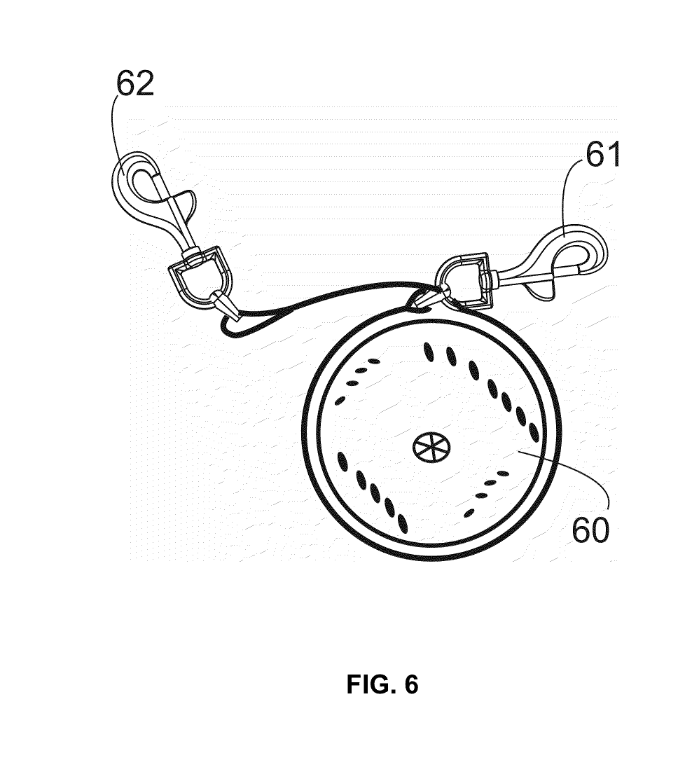

According to FIG. 6, the present sound making device 60 can also be constructed as an external component and can be attached to any leash by a fastening means to collar from one end 61 and to the leash from other end 62. The purpose of having the sound making device 60 is to attach it to the existing leash, collar or jacket. And also the device 60 can be attached to any place that is convenient for the dog to bite it depending on the length and the height of the dog.

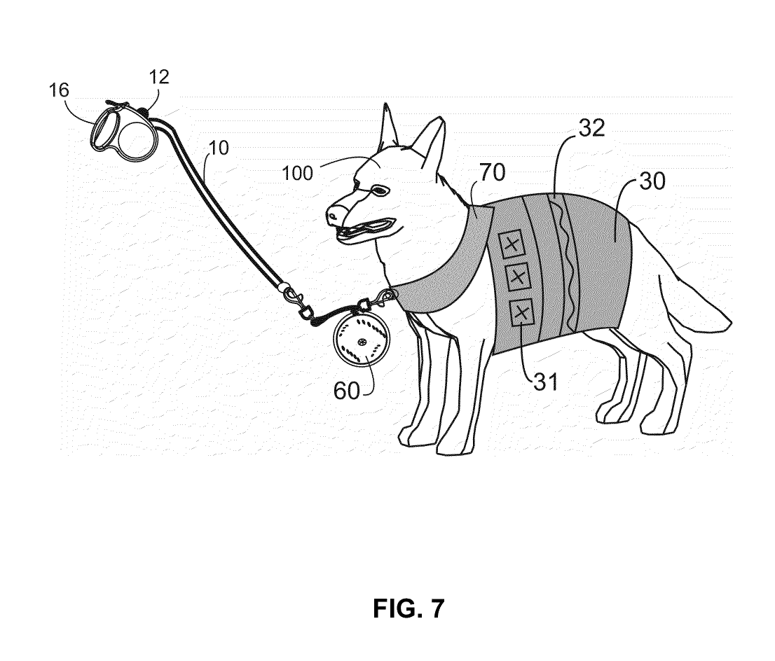

FIG. 7 shows the sound making devices 60 carrying on the collar 70 and the leash 10 together. The dog 100 can communicate with the sound making device 31 designed in the jacket 30 or the sound making device 60 attached to the collar 70 and the leash 10.

A variety of sound making air pouch devices designed for specific responses and for specific tasks or requests for communication, protection or other purposes.

Sound making air pouch device produces multiple sounds with a variety of tones each for specific action and for multiple commands. The animal can be trained to respond to each action or command corresponding to a note pushed by the user.

The present invention, as a leash, allows a human to call an animal, or demand a command from an animal, such as sitting, by pushing a device and not using their voice. The invention allows animals to communicate with humans by activating a sound for certain demands, such as biting a note when they want to go for a walk.

The multiple sounds of the present invention are used to train an animal, with each action or command corresponding to a note pushed by the user. A high pitched toned can be used near the handle, because dogs respond with excitement to higher tones. A low pitched tone can be used around the collar, to signal bad behaviours, as dogs respond to lower tones with less enthusiasm than higher tones

A low pitched tone can be used near the latch of the leash, so when the dog pulls too hard on the leash, a lower sound will be heard, to signal bad behaviour.

The device may have multiple tones, creating the sound of a harmonica instrument when activated. The device may have one tone. The device may have two tones. The device may have three tones with different sounds or all the same or any combination. High tones generally enforce good behaviour. Low tones generally enforce bad behaviour. The device may be used for training purposes, or as an alert for dogs not trained with the device.

Another embodiment of the present invention is an air-activated music device which may embody distinct smells or aromas that evoke natural sensations from a dog. For example, a music device of the present invention may embody the smell of dog food for “feed me” sound. Another example is that the music device may embody the smell of roses for a “let me outside” sound. These sounds are distinct in their tone, so that a human knows what command is being asked of by the animal.

In this embodiment, for encouraging a dog to bite a specific sound making device, it is possible to add another distinguished characteristic to the sound making device, such as smell and aroma or flavour (taste). These characteristics resemble a specific function for the sound making device of the present invention. For example, when a dog bites a sound making device that smell and taste like dog-food, it means that the dog is hungry and needs food.

The flavour can be selected from different groups of flavours that dogs react to positively, motivating them to bite a specific sound making device to communicate with the human about their needs. These different flavours are foods that dogs enjoy, such as meats and sweets.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A device to facilitate communication between a human and an animal, comprising:
a. a handle having a body;
b. a leash having a distal end and a proximal end, wherein said distal end connects to said animal by a first connection means and said proximal end connects to said handle by a second connection means;
c. a first plurality of sound making devices attached to said leash close to said distal end to be easily accessible to the animal, wherein said first plurality of sound making devices making distinguishable sounds; and
d. a second plurality of sound making devices attached to said handle body, wherein said second plurality of sound making devices making distinguishable sounds;
whereby said human communicates with said animal by selectively activating one or more of said second plurality of sound making devices and said animal communicates with said human by selectively activating one or more of said first plurality of sound making devices.

2. The device for communication of claim 1, wherein said sound making devices being selected from the groups consisting of a reed, a whistle and a horn.

3. The device for communication of claim 1, wherein each said sound making device comprising of an audible tone producing device embedded in an air pocket.

4. The device for communication of claim 1, wherein said connection means being a hook.

5. The device for communication of claim 1, wherein said leash further having a Velcro strap or buttons or clips to attach a plurality of equipment.

6. The device for communication of claim 1, wherein said first sound making device is located 8 inches to 24 inches away from the distal end of the leash.

7. The device for communication of claim 1, wherein said first sound making device is made of a material resemble a specific smell and flavour.

8. A device to facilitate communication between a human and an animal, comprising:
a. a handle having a handle-body;
b. a collar having a collar-body to go around said animal's neck;
c. a first plurality of sound making devices attached to said collar-body, wherein said first plurality of sound making devices making distinguishable sounds; and
d. a second plurality of sound making devices attached to said handle body, wherein said second plurality of sound making devices making distinguishable sounds;
whereby said human communicates with said animal by selectively activating one or more of said second plurality of sound making devices and said animal communicates with said human by selectively activating one or more of said first plurality of sound making devices.

9. The device for communication of claim 8, wherein said first sound making device is located near the throat of said animal.

10. The device for communication of claim 8, wherein said sound making device comprises of an audible tone producing device embedded in an air pocket.

11. The device for communication of claim 8, wherein said sound making device being selected from the groups consisting of a reed, a whistle and a horn.

12. The device for communication of claim 8, wherein said collar further having a Velcro strap to attach a plurality of equipment.

13. The device for communication of claim 8, wherein said first sound making device is made of a material resemble a specific smell and flavour.

14. A device for communication of an animal with a human comprising of
a. a handle having a handle-body;
b. a jacket around said animal having a jacket-body, wherein said jacket body having a distal end and a proximal end;
c. a first plurality of sound making devices attached to said jacket-body, wherein said first plurality of sound making devices making distinguishable sounds upon activation by the animal; and
d. a second plurality of sound making devices attached to said handle body, wherein said second plurality of sound making devices making distinguishable sounds;
whereby said human communicates with said animal by selectively activating one or more of said second plurality of sound making devices and said animal communicates with said human by selectively activating one or more of said first plurality of sound making devices.

15. The device for communication of claim 14, wherein said first sound making device is located at said distal end of said jacket-body.

16. The device for communication of claim 14, wherein said sound making device comprises of an audible tone producing device embedded in an air pocket.

17. The device for communication of claim 14, wherein said sound making device being selected from the groups consisting of a reed, a whistle and a horn.

18. The device for communication of claim 14, wherein said first sound making device is made of a material resemble a specific smell and flavour.

19. The device for communication of claim 14, wherein said sound making device comprises of a metallic structure which hangs loosely and makes a sound as they clash together.

20. The device for communication of claim 14, wherein said jacket further having a Velcro strap or buttons or clips to attach a plurality of equipment.
